(19) United States
(12) Patent Application Publication
(10) Pub. No.: US 2026/0181480 A1
(43) Pub. Date: Jun. 25, 2026

(54) COMMUNICATION DEVICE, CONTROL METHOD OF COMMUNICATION DEVICE, AND STORAGE MEDIUM

(71) Applicant: HONDA MOTOR CO., LTD., Tokyo (JP)

(72) Inventor: Shohei TSUKAHARA, Tokyo (JP)

(21) Appl. No.: 19/349,391

(22) Filed: Oct. 3, 2025

(30) Foreign Application Priority Data
Dec. 23, 2024 (JP) 2024-226500

(51) Int. Cl. H04W 28/08; H04W 76/10; H04W 88/04

(52) U.S. Cl. CPC H04W 28/0983; H04W 76/10; H04W 88/04

(57) ABSTRACT

A communication device capable of relaying data acquired via a network to at least one another communication device, the communication device comprising: an acquisition unit configured to acquire information of a maximum throughput of the communication device; a connection unit configured to connect with the at least one another communication device; and a determination unit configured to determine a transfer throughput for transferring data to each of the at least one another communication device, based on a connected number of the at least one another communication device and the information of the maximum throughput.

### CROSS-REFERENCE TO RELATED APPLICATION(S)

This application claims priority to and the benefit of Japanese Patent Application No. 2024-226500, filed December 23, 2024, the entire disclosure of which is incorporated herein by reference.

### BACKGROUND OF THE INVENTION

### Field of the Invention

The present invention relates to a communication device, a control method of the communication device, and a storage medium.

### Description of the Related Art

Japanese Patent Laid-Open No. 2006-518970 discloses a technique for maximizing the packet throughput in a network environment.

However, the technique described in Japanese Patent Laid-Open No. 2006-518970 has a problem that it is difficult to appropriately distribute the throughput in a communication device having a function of relaying data that has been acquired from a network to another communication device, and the communication device itself also uses contents or the like while using the data.

### SUMMARY OF THE INVENTION

The present invention has been made in view of the above problem, and provides a technique of appropriately distributing the throughput while having a function of relaying data that has been acquired from a network to another communication device.

According to one aspect of the present invention, there is provided a communication device capable of relaying data acquired via a network to at least one another communication device, the communication device comprising: an acquisition unit configured to acquire information of a maximum throughput of the communication device; a connection unit configured to connect with the at least one another communication device; and a determination unit configured to determine a transfer throughput for transferring data to each of the at least one another communication device, based on a connected number of the at least one another communication device and the information of the maximum throughput.

### BRIEF DESCRIPTION OF THE DRAWINGS

FIG. 1 is a diagram illustrating an example of a configuration of a communication system according to one embodiment;

FIG. 2 is a diagram illustrating an example of a hardware configuration of a communication device included in a vehicle according to one embodiment;

FIG. 3 is a diagram illustrating an example of a hardware configuration of another communication device according to one embodiment;

FIG. 4 is a diagram illustrating an example of a functional configuration of the communication device included in the vehicle according to one embodiment;

FIG. 5 is a flowchart illustrating a procedure of processing performed by the communication device included in the vehicle according to a first embodiment;

FIG. 6 is a flowchart illustrating a procedure of processing performed by a communication device included in the vehicle according to a second embodiment;

FIG. 7 is a flowchart illustrating a procedure of processing performed by a communication device included in the vehicle according to a third embodiment;

FIG. 8 is an explanatory diagram of the throughput according to the first embodiment;

FIG. 9 is an explanatory diagram of the throughput according to the third embodiment;

FIG. 10 is an explanatory diagram of the throughput according to a fourth embodiment;

FIG. 11 is an explanatory diagram of the throughput according to the second embodiment;

FIG. 12 is an explanatory diagram of the throughput according to the second embodiment;

FIG. 13 is a flowchart illustrating a procedure of processing performed by a communication device included in the vehicle according to the fourth embodiment;

FIG. 14 is a flowchart illustrating a procedure of processing performed by the communication device included in the vehicle according to a fifth embodiment;

FIG. 15 is an explanatory diagram of the throughput according to the fifth embodiment; and

FIG. 16 is an explanatory diagram of the throughput according to the fifth embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

### System Configuration

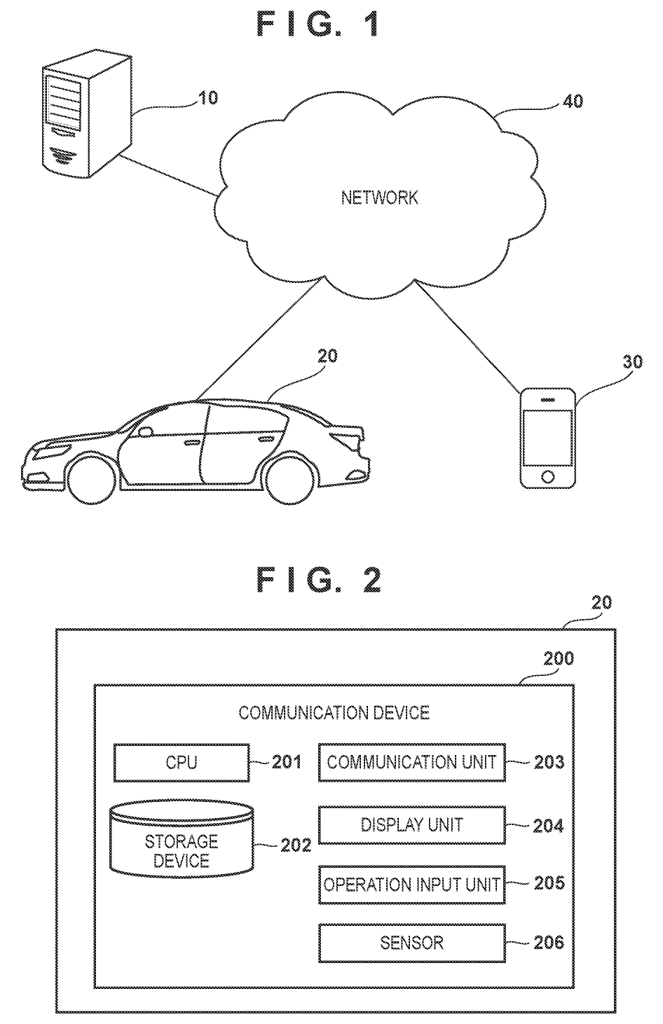

FIG. 1 is a diagram illustrating a configuration example of a communication system according to the present embodiment. In FIG. 1, a reference numeral 10 denotes a server apparatus (an information processing apparatus). A reference numeral 20 is a vehicle, for example, a four-wheeled vehicle. However, the vehicle is not limited to a four-wheeled vehicle, and may be a three-wheeled vehicle, a two-wheeled vehicle, or the like. A reference numeral 30 denotes a communication device (for example, a smartphone, a tablet terminal, or the like) that is, for example, a device carried by an occupant of the vehicle 20. A reference numeral 40 denotes a network. The server apparatus 10, the vehicle 20, and the communication device are connected via the network 40. The vehicle 20 has a function of receiving data that has been transmitted from the server apparatus 10 using tethering communication, and transferring (relaying) the data to the communication device 30. Similarly, the communication device 30 may have a function of receiving data that has been transmitted from the server apparatus 10 using the tethering communication, and transferring (relaying) the data to the vehicle 20.

### Hardware Configuration

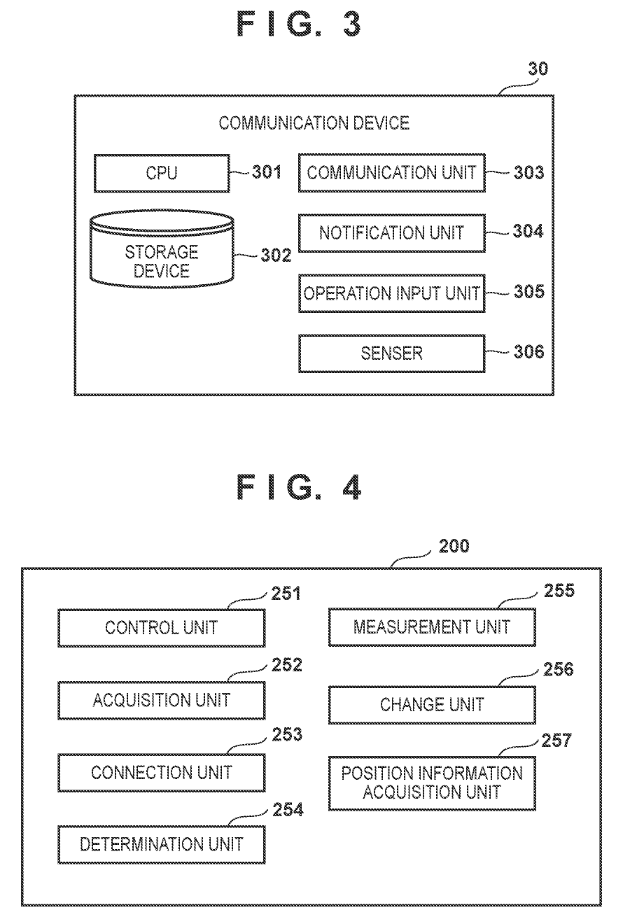

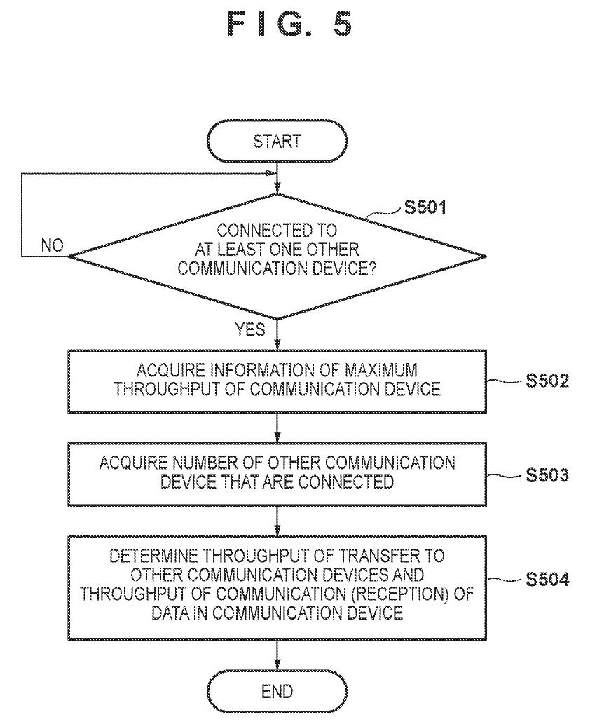

Next, hardware configuration examples of the vehicle 20 and the communication device 30 according to one embodiment will be described with reference to FIGS. 2 and 3.

As illustrated in FIG. 2, the vehicle 20 includes a communication device 200, which is mounted on the vehicle. The communication device 200 includes a CPU 201, a storage device 202, a communication unit 203, a display unit 204, an operation input unit 205, and a sensor 206. Note that other configurations such as a steering device and a driving device of the vehicle 20 are omitted. The communication device 200 may be, for example, an in-vehicle display device, and is capable of acquiring navigation information to provide a user with a route guidance to a destination and presenting congestion information.

A control operation of the communication device 200 is achieved by the CPU 201 reading and executing a computer program stored in the storage device 202. The CPU 201 may include one or more CPUs. The storage device 202 includes one or more memories that store several types of information. For example, information that has been received from another device, a computer program to be read and executed by the CPU 201, and the like are stored.

The communication unit 203 has a function of communicating with another device in a wired or wireless manner through the network 40. The display unit 204 displays various videos, images, messages, and the like to the user. The operation input unit 205 receives inputs of various operation instructions from the user. The sensor 206 includes a GPS/GNSS sensor, and is capable of acquiring position information of the vehicle 20.

As illustrated in FIG. 3, the communication device 30 includes a CPU 301, a storage device 302, a communication unit 303, a display unit 304, an operation input unit 305, and a sensor 306. The communication device 30 is, for example, a smartphone or a tablet terminal carried by an occupant.

A control operation of the communication device 30 is achieved by the CPU 301 reading and executing a computer program stored in the storage device 302. The CPU 301 may include one or more CPUs. The storage device 302 includes one or more memories that store several types of information. For example, information that has been received from another device, a computer program to be read and executed by the CPU 301, and the like are stored.

The communication unit 303 has a function of communicating with another device in a wired or wireless manner through the network 40. The display unit 304 displays various videos, images, messages, and the like to the user. The operation input unit 305 receives inputs of various operation instructions from the user. The sensor 306 includes a GPS/GNSS sensor, and is capable of acquiring position information of the communication device 30.

### Functional Configuration

Next, a functional configuration example of the communication device 200, which is included in the vehicle 20, according to one embodiment will be described with reference to FIG. 4. As illustrated in FIG. 4, the communication device 200 is a communication device capable of relaying data that has been acquired via the network 40 to one or more other communication devices 30, by using, for example, cellular communication. The communication device 200 operates as an access point, and one or more other communication devices 30 each operate as a station. The communication device 200 includes a control unit 251, an acquisition unit 252, a connection unit 253, a determination unit 254, a measurement unit 255, a change unit 256, and a position information acquisition unit 257.

The control unit 251 controls the operation of the entirety of the communication device 200. The acquisition unit 252 acquires information of the maximum throughput of the communication device 200. The information of the maximum throughput is a specified value, and is stored beforehand in the storage device 202 of the communication device 200. The connection unit 253 is connected with one or more other communication devices 30, by using a tethering communication function. As the tethering communication here, for example, Wi-Fi tethering communication, Bluetooth (registered trademark) tethering communication, or USB tethering communication is available.

The determination unit 254 determines a transfer throughput (a transfer speed, a transfer rate) for transferring data to each of one or more other communication devices 30, based on the connected number of one or more other communication devices 30, which are connected with the communication device 200, and the information of the maximum throughput. The measurement unit 255 measures a current throughput at which the communication device 200 communicates (receives) data from the network 40. The change unit 256 changes the current throughput or the transfer throughput, based on a difference between the current throughput that has been measured by the measurement unit 255 and the throughput that has been determined by the determination unit 254. The position information acquisition unit 257 acquires position information of each of one or more other communication devices 30.

### Processing

Next, a procedure of processing performed by the communication device 200, which is included in the vehicle 20, according to the present embodiment will be described with reference to a flowchart of FIG. 5. In S501, the control unit 251 determines whether the communication device 200 is connected with one or more other communication devices 30 by the connection unit 253. In a case where the determination in this step is Yes, the processing proceeds to S502. On the other hand, in a case where the determination in this step is No, the processing waits.

In S502, the acquisition unit 252 acquires information of the maximum throughput of the communication device 200. The maximum throughput of the communication device 200 corresponds to the performance of the communication device 200, and for example, information stored in the storage device 202 of the communication device 200 may be read and acquired. In S503, the control unit 251 calculates and acquires the connected number of the other communication devices 30, which are connected by the connection unit 253.

In S504, the determination unit 254 determines (allocates) the transfer throughput for transferring data to each of one or more other communication devices 30, based on the connected number of one or more other communication devices 30 and the information of the maximum throughput. In addition, the throughput for communicating (receiving) data in the communication device 200 may be further determined (allocated).

For example, the determination unit 254 may determine, as the transfer throughput, a value obtained by dividing the maximum throughput by the total number including the connected number of the other communication devices 30 and the communication device 200. That is, each transfer throughput may be determined so that the transfer throughputs respectively allocated to the other communication devices 30 (smartphones, tablet terminals, or the like) are equal to each other. In addition, the determination unit 254 may further determine a value obtained by dividing the maximum throughput by the total number including the connected number of the other communication devices 30 and the communication device 200, as the throughput for communicating (receiving) data in the communication device 200. That is, the communication device 200 and the respective communication devices 30 may be determined so that the throughputs are all equal to each other.

Here, a specific example will be described with reference to FIG. 8. It is assumed that the maximum throughput of the communication device 200 is 100 Mbps and the connected number of the other communication devices 30, which are connected with the communication device 200, is four. In this case, “the maximum throughput 100 Mbps divided by 5 (the total number including 4, which is the connected number of the other communication devices 30, and 1, which is the communication device 200 itself) equals 20 Mbps per device”, and 20 Mbps is determined as each transfer throughput for the other communication devices 30 and the throughput for communicating (receiving) data in the communication device 200. That is, the throughput for communicating (receiving) data in the communication device 200 is 20 Mbps, and the transfer throughput for each communication device 30 is also 20 Mbps. Accordingly, it becomes possible to equally (fairly) allocate the throughput to each device.

As described heretofore, in the present embodiment, the transfer throughput for transferring data to each of the other communication devices is determined, based on the connected number of the other communication devices, each of which functions as a station, and the information of the maximum throughput of the communication device, which functions as an access point.

Accordingly, it becomes possible to distribute an appropriate throughput including a self-terminal (the communication device) and the connected terminals (the other communication devices).

### Modifications

In the first embodiment, the description has been made with regard to a case where the throughput is equally distributed, but there is no limitation to this example. For example, priority may be given to the throughput for communicating (receiving) data in the communication device 200, and control may be conducted to have a predetermined times (for example, twice) the transfer throughput for the other communication device 30.

As described above, it is assumed that the maximum throughput of the communication device 200 is 100 Mbps and the connected number of the other communication devices 30, which are connected with the communication device 200, is four. In this case, in a case where the transfer throughput is X Mbps, the throughput for communicating (receiving) data in the communication device 200 is 2X Mbps. Since 2X + X + X + X + X = 100 Mbps, that is, 6X = 100 Mbps is established, it is possible to calculate X = 16.7 Mbps. Therefore, priority distribution may be performed so that the throughput for communicating (receiving) data in the communication device 200 is 33.4 Mbps and the transfer throughput for each of the other communication devices 30 is 16.7 Mbps.

### Second Embodiment

In the present embodiment, an example of changing the throughput will be described. Since a system configuration and a device configuration are similar to those in the first embodiment, their descriptions will be omitted.

### Processing

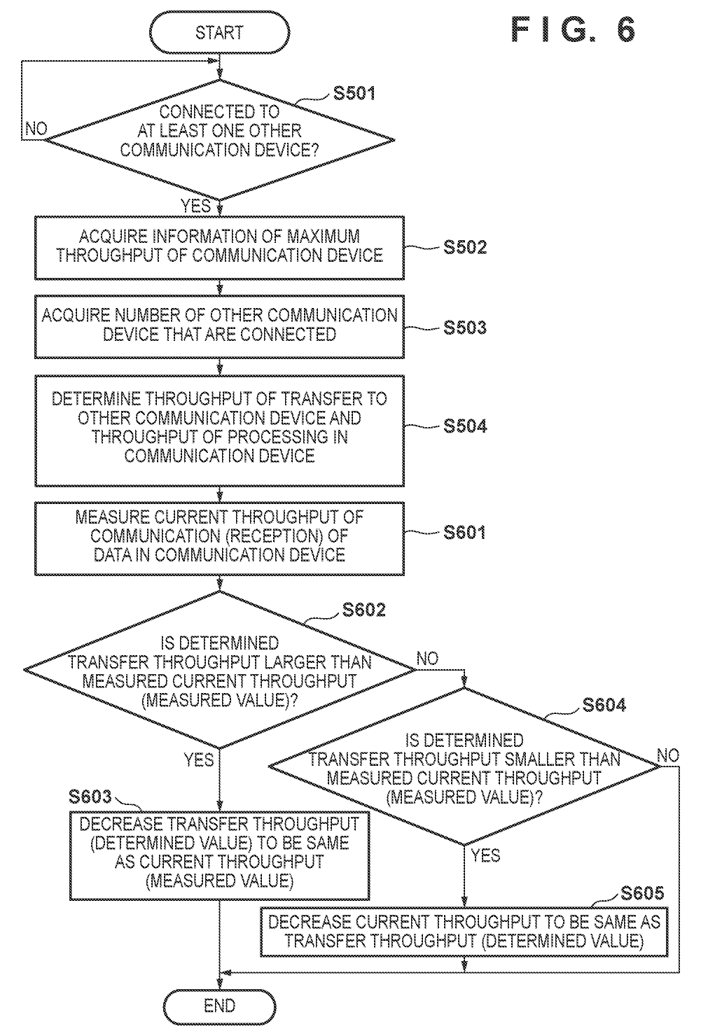

Next, a procedure of processing performed by the communication device 200, which is included in the vehicle 20, according to the present embodiment will be described with reference to a flowchart of FIG. 6. Since each process of S501 to S504 is similar to the processing described with reference to FIG. 5 in the first embodiment, the descriptions will be omitted.

In S601, the measurement unit 255 measures a current throughput for communicating (receiving) data in the communication device 200. This processing is for measuring the throughput of the communication device 200 itself.

In S602, the control unit 251 determines whether the transfer throughput determined (calculated) in S504 is larger than the current throughput that has been measured (a measured value). In a case where the determination in this step is Yes, the processing proceeds to S603. On the other hand, in a case where the determination in this step is No, the processing proceeds to S604. In S603, the change unit 256 decreases the transfer throughput (a determined value) to be equal to the current throughput (the measured value).

In S604, the control unit 251 determines whether the transfer throughput determined (calculated) in S504 is smaller than the current throughput that has been measured (the measured value). In a case where the determination in this step is Yes, the processing proceeds to S605. On the other hand, in a case where this step is No, the processing ends without making a change. In S605, the change unit 256 decreases the current throughput, and changes the current throughput to be equal to the transfer throughput (the determined value).

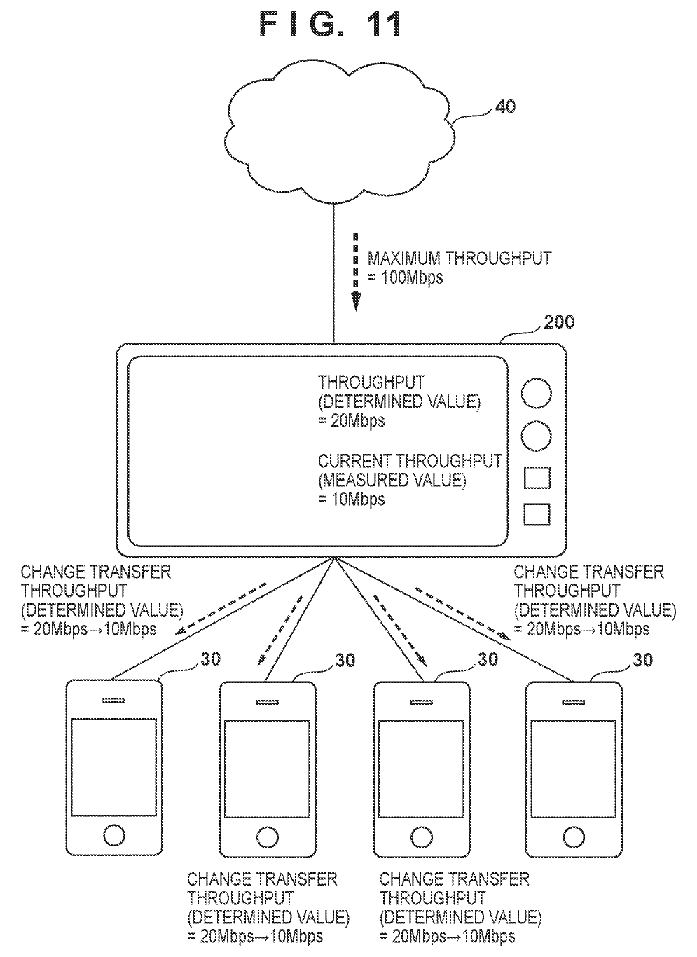

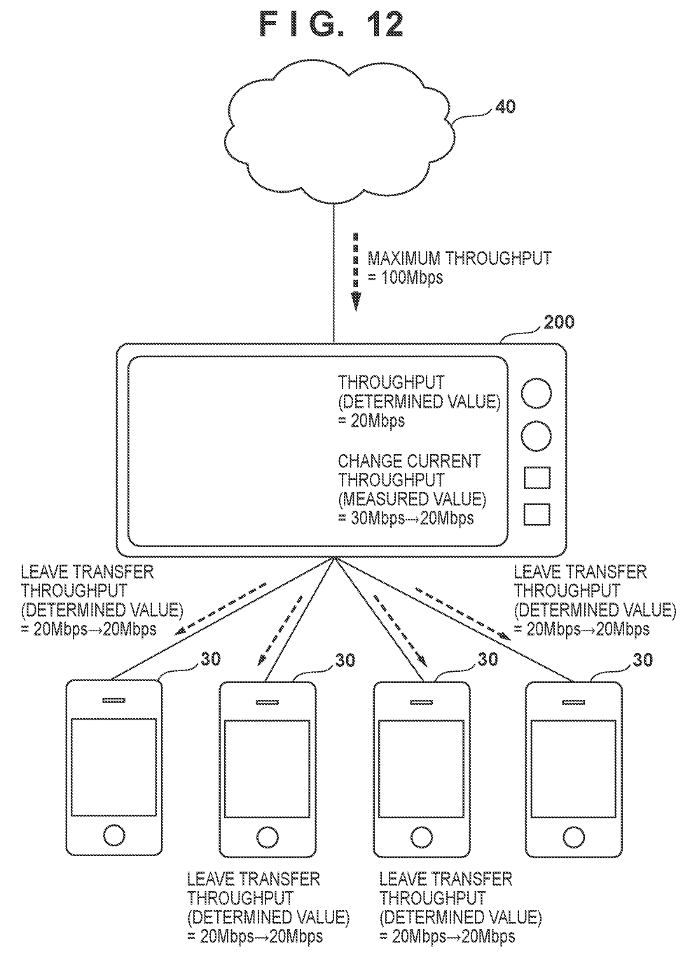

Here, a specific example will be described with reference to FIGS. 11 and 12. FIG. 11 illustrates a case of the throughput (the determined value) = the transfer throughput (the determined value) = 20 Mbps and the current throughput (the measured value) of the communication device 200 = 10 Mbps. In this case, since the determined transfer throughput (20 Mbps) is larger than the measured current throughput (the measured value) (10 Mbps), the determination in S602 is Yes, and processing proceeds to S603. Then, in S603, the transfer throughput (the determined value) = 20 Mbps is decreased and changed to be equal to the current throughput (the measured value) = 10 Mbps. That is, the transfer throughput for each of the other communication devices 30 becomes 10 Mbps, and is controlled to be the same value with the current throughput (10 Mbps) in the processing in the communication device 200.

FIG. 12 illustrates a case of the throughput (the determined value) = the transfer throughput (the determined value) = 20 Mbps and the current throughput (the measured value) of the communication device 200 = 30 Mbps. In this case, the determined transfer throughput (20 Mbps) is smaller than the measured current throughput (the measured value) (30 Mbps), thus the determination in S604 is Yes, and the processing proceeds to S605. Then, in S605, the current throughput (the measured value) = 30 Mbps is decreased and changed to be equal to the transfer throughput (the determined value) = 20 Mbps. That is, the transfer throughput for each of the other communication devices 30 remains at 20 Mbps, and the current throughput in the processing in the communication device 200 is also controlled to 20 Mbps.

As described heretofore, in the present embodiment, the transfer throughput or the throughput is changed, based on the determined transfer throughput (that is the determined throughput in the communication device 200) and the measured value of the current throughput in the processing in the communication device 200. For example, the respective throughputs are controlled to be equal to each other.

Accordingly, it becomes possible to distribute an appropriate throughput including a self-terminal (the communication device) and the connected terminals (the other communication devices).

### Third Embodiment

In the present embodiment, description will be made with regard to another example of determining the transfer throughput for the other communication device 30. Since a system configuration and a device configuration are similar to those in the first embodiment, their descriptions will be omitted.

### Processing

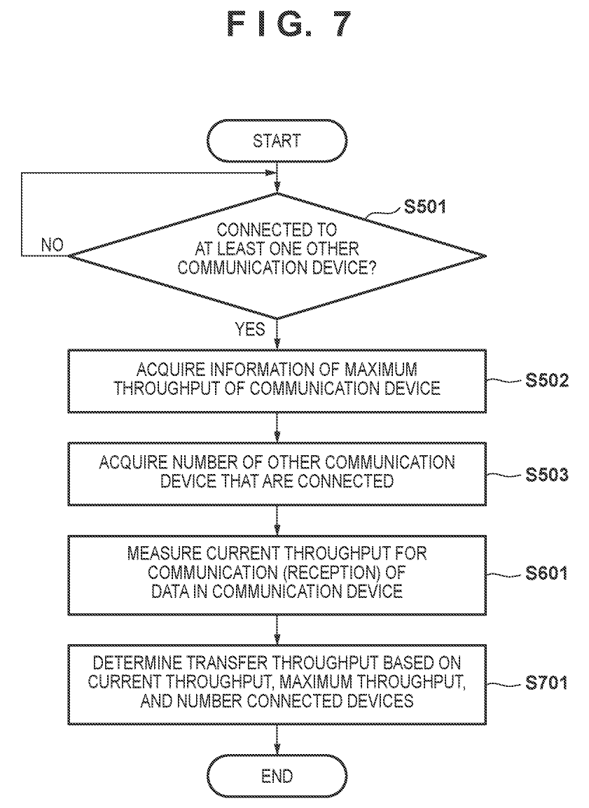

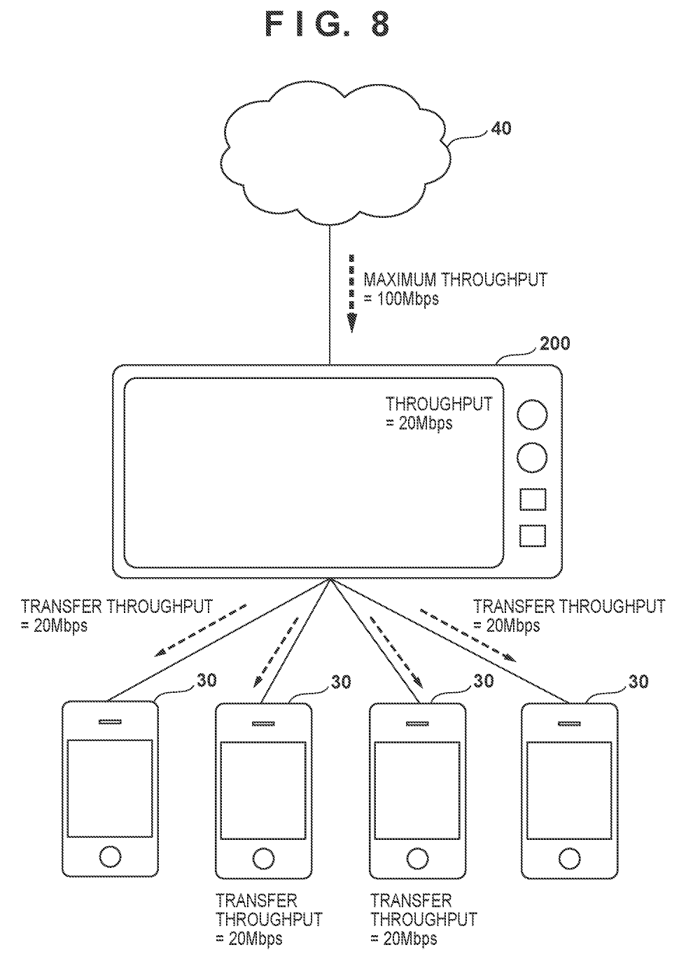

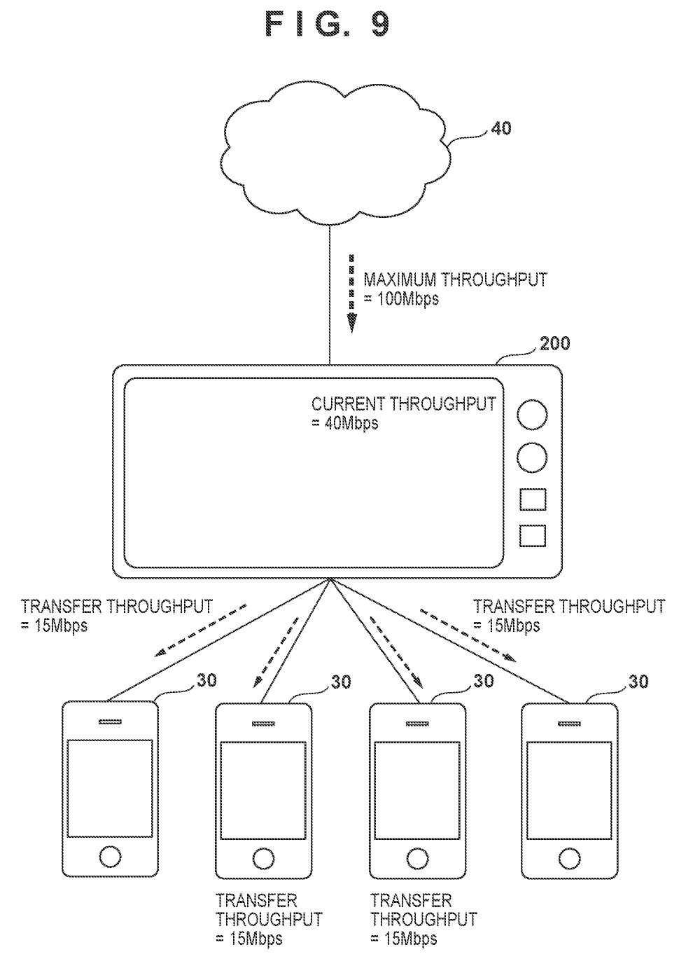

Next, a procedure of processing performed by the communication device 200, which is included in the vehicle 20, according to the present embodiment will be described with reference to a flowchart of FIG. 7. Each process of S501 to S504 is similar to the processing that has been described with reference to FIG. 5 in the first embodiment. The processing of S601 is similar to the processing that has been described with reference to FIG. 6 in the second embodiment. Thus, their descriptions will be omitted.

In S701, the determination unit 254 determines the transfer throughput, based on the current throughput, the maximum throughput, and the connected number. For example, a measured value is subtracted from the maximum throughput to obtain a subtraction result, such a subtraction result is divided by the connected number of the other communication devices 30 to obtain a division result, and such a division result is determined as the transfer throughput for each of the other communication devices 30.

Here, a specific example will be described with reference to FIG. 9. It is assumed that the maximum throughput of the communication device 200 is 100 Mbps and the connected number of the other communication devices 30, which are connected with the communication device 200, is four. In addition, it is assumed that the current throughput (the measured value) in the processing in the communication device 200 is 40 Mbps. In this case, “the current throughput (the measured value) 40 Mbps is subtracted from the maximum throughput 100 Mbps, and a subtraction result divided by 4, which is the connected number of the communication devices 30, equals 15 Mbps per device”, and 15 Mbps is determined as each transfer throughput for the other communication devices 30. The throughput in the communication device 200 is determined as the measured value of 40 Mbps. That is, the throughput for communicating (receiving) data in the communication device 200 is 40 Mbps, and the transfer throughput for each communication device 30 is 15 Mbps. Accordingly, it becomes possible to equally (fairly) allocate the throughput to each of the other communication devices that are connected.

### Fourth Embodiment

In the present embodiment, description will be made with regard to another example of determining the transfer throughput for the other communication device 30. Since a system configuration and a device configuration are similar to those in the first embodiment, their descriptions will be omitted.

### Processing

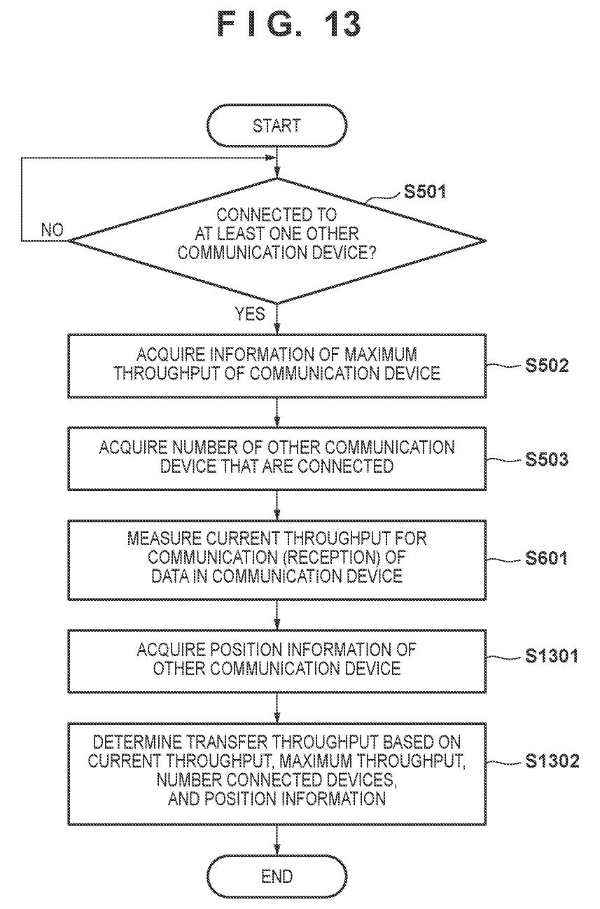

Next, a procedure of processing performed by the communication device 200, which is included in the vehicle 20, according to the present embodiment will be described with reference to a flowchart of FIG. 13. Each process of S501 to S504 is similar to the processing that has been described with reference to FIG. 5 in the first embodiment. The processing of S601 is similar to the processing that has been described with reference to FIG. 6 in the second embodiment. Thus, their descriptions will be omitted.

In S1301, the position information acquisition unit 257 acquires the position information of the other communication devices 30 from each communication device 30.

In S1302, the determination unit 254 determines the transfer throughput, based on the current throughput, the maximum throughput, the connected number, and the position information. For example, by using the acquired position information, the determination unit 254 may determine the transfer throughput that differs depending on whether the other communication device 30 is located inside or outside the vehicle 20.

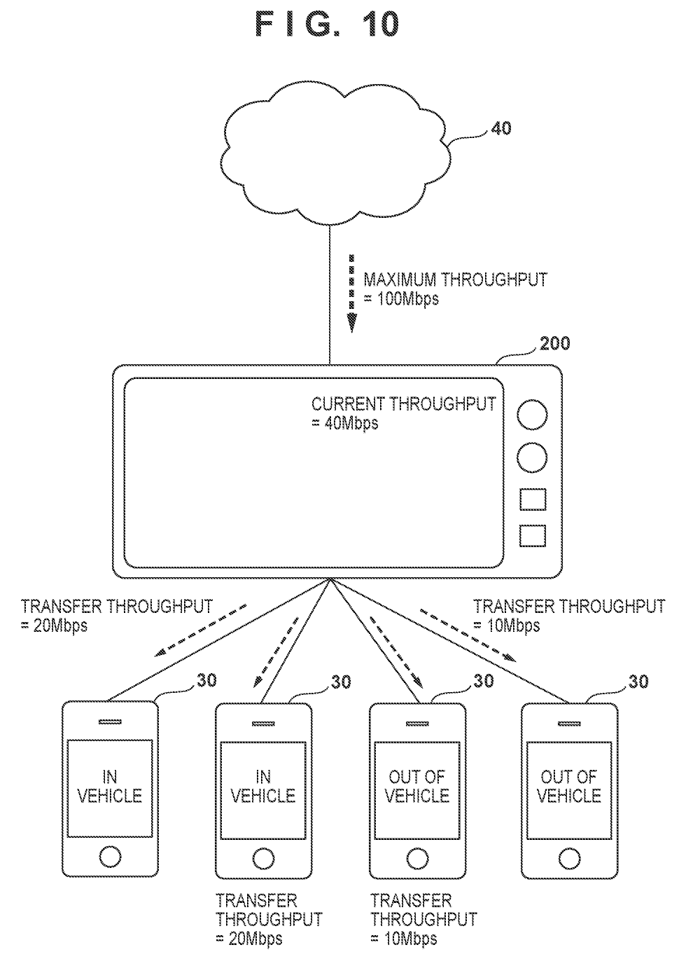

Here, a specific example will be described with reference to FIG. 10. It is assumed that the maximum throughput of the communication device 200 is 100 Mbps and the connected number of the other communication devices 30, which are connected with the communication device 200, is four. In addition, it is assumed that the current throughput (the measured value) for communicating (receiving) data in the communication device 200 is 40 Mbps. It is assumed that two of four other communication devices 30 are located inside of the vehicle 20 and remaining two of them are located outside the vehicle 20.

In this case, a change may be made so that the transfer throughput for the other communication device 30, which is located inside the vehicle, is larger than the transfer throughput for the other communication device 30, which is located outside the vehicle. Note that a case of being located inside the vehicle means a case where an occupant who carries the other communication device 30 is riding in the vehicle 20, and a case of being located outside the vehicle means a case where an occupant who carries the other communication device 30 is located outside the vehicle, although the occupant is located in the surroundings of the vehicle 20. For example, it is assumed that the vehicle is parked in a parking lot of a service area on an expressway and some occupants are outside the vehicle.

In this situation, the maximum throughput 100 Mbps - the current throughput (the measured value) 40 Mbps = 60 Mbps, which is allocated to four connected communication devices 30. For example, it is considered that X Mbps is allocated to the other communication device 30, which is located outside the vehicle, and 2X Mbps is allocated to the other communication device 30, which is located inside the vehicle. In such a case, since X + X + 2X + 2X = 60 Mbps is established, X = 10 Mbps is calculated. Therefore, a change is made so that 10 Mbps is allocated to the other communication device 30, which is located outside the vehicle, and 20 Mbps is allocated to the other communication device 30, which is located inside the vehicle. The throughput in the communication device 200 is determined as the measured value of 40 Mbps. That is, the throughput for communicating (receiving) data in the communication device 200 is 40 Mbps, the transfer throughput for the communication device 30, which is located inside the vehicle, is 20 Mbps, and the transfer throughput for the communication device 30, which is located outside the vehicle, is 10 Mbps. Accordingly, it becomes possible to allocate a large throughput to the user who is present in the vehicle among the other communication devices that are connected.

### Modifications

Note that in the fourth embodiment, the description has been made with regard to an example in which different throughputs are allocated depending on whether the other communication device 30 is located inside the vehicle or outside the vehicle, but there is no limitation to this example. The determination unit 254 may determine the transfer throughput, based on the position information of the other communication device 30, so that the transfer throughput for the other communication device 30, which is located in the driver seat or the front passenger seat of the vehicle 20, is larger than the transfer throughput for the other communication device 30, which is located in a rear passenger seat.

Note that in identifying the seat, imaging information may be used instead of the position information. For example, an image of an occupant in each seat is captured by use of an in-vehicle camera (not illustrated) provided in the vehicle 20, and a person is identified from the captured image. Furthermore, the communication device 200 acquires device information (for example, owner information) of the other communication devices 30 from each communication device 30, and identifies the seat on which the user who carries the other communication device 30 is seated. Accordingly, it becomes possible to determine whether each of the other communication devices 30 is located in the driver seat, the front passenger seat, or the rear passenger seat.

### Fifth Embodiment

In the second to fourth embodiments, the description has been made with regard to an example in which the throughput for communicating (receiving) data in the communication device 200 is measured, and the throughput is changed or determined with use of such a measured value. On the other hand, in the present embodiment, description will be made with regard to an example in which a current entire transfer throughput of the communication device 200, which functions as an access point (AP), is measured, and the throughput is changed with use of such a measured value. Since a system configuration and a device configuration are similar to those in the first embodiment, their descriptions will be omitted.

### Processing

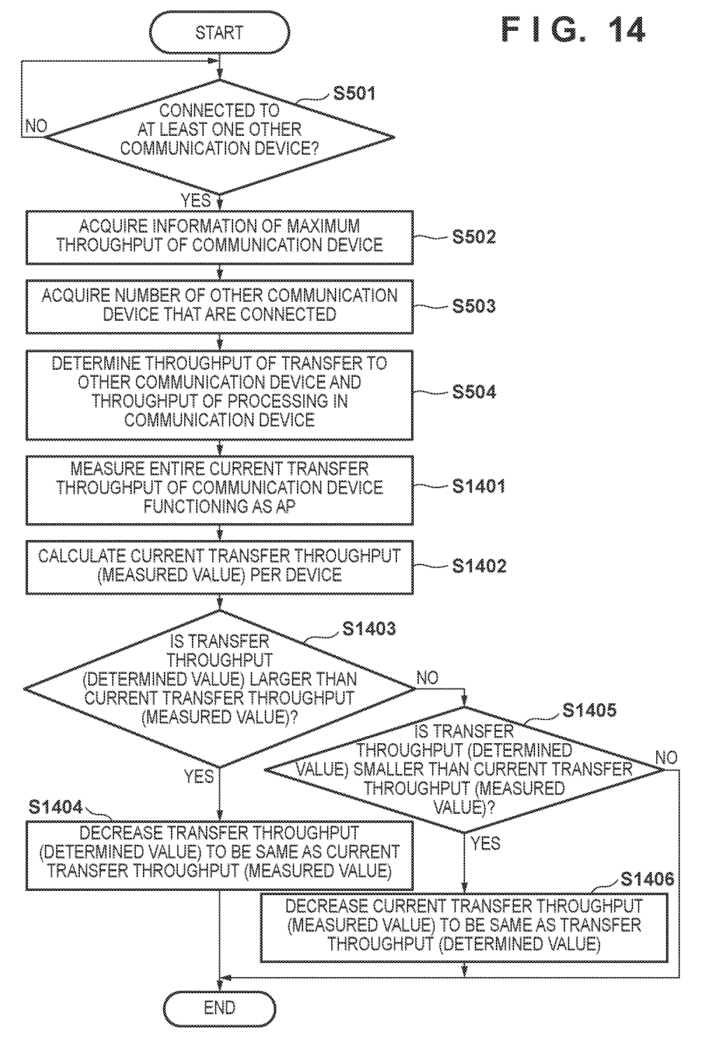

Next, a procedure of processing performed by the communication device 200, which is included in the vehicle 20, according to the present embodiment will be described with reference to a flowchart of FIG. 14. Since each process of S501 to S504 is similar to the processing described with reference to FIG. 5 in the first embodiment, the descriptions will be omitted.

In S1401, the measurement unit 255 measures the current entire transfer throughput of the communication device 200, which functions as an access point (AP). This throughput does not include the throughput in the processing performed by the communication device 200 itself, and means the transfer throughput for the entirety of the other communication devices 30.

In S1402, the control unit 251 calculates the current transfer throughput (the measured value) per communication device of the other communication devices 30. For example, a value is obtained by dividing the entire transfer throughput measured in S1401 by the connected number of the other communication devices 30, and such a value is calculated as the current transfer throughput (the measured value) per communication device.

In S1403, the control unit 251 determines whether the transfer throughput (the determined value) is larger than the current transfer throughput (the measured value). In a case where the determination in this step is Yes, the processing proceeds to S1404. On the other hand, in a case where the determination in this step is No, the processing proceeds to S1405.

In S1404, the change unit 256 decreases the transfer throughput (the determined value) to be equal to the current transfer throughput (the measured value). In S1405, the control unit 251 determines whether the transfer throughput (the determined value) is smaller than the current transfer throughput (the measured value). In a case where the determination in this step is Yes, the processing proceeds to S1406. On the other hand, in a case where this step is No, the processing ends without making a change. In S1406, the change unit 256 decreases the current transfer throughput (the measured value) to be equal to the transfer throughput (the determined value).

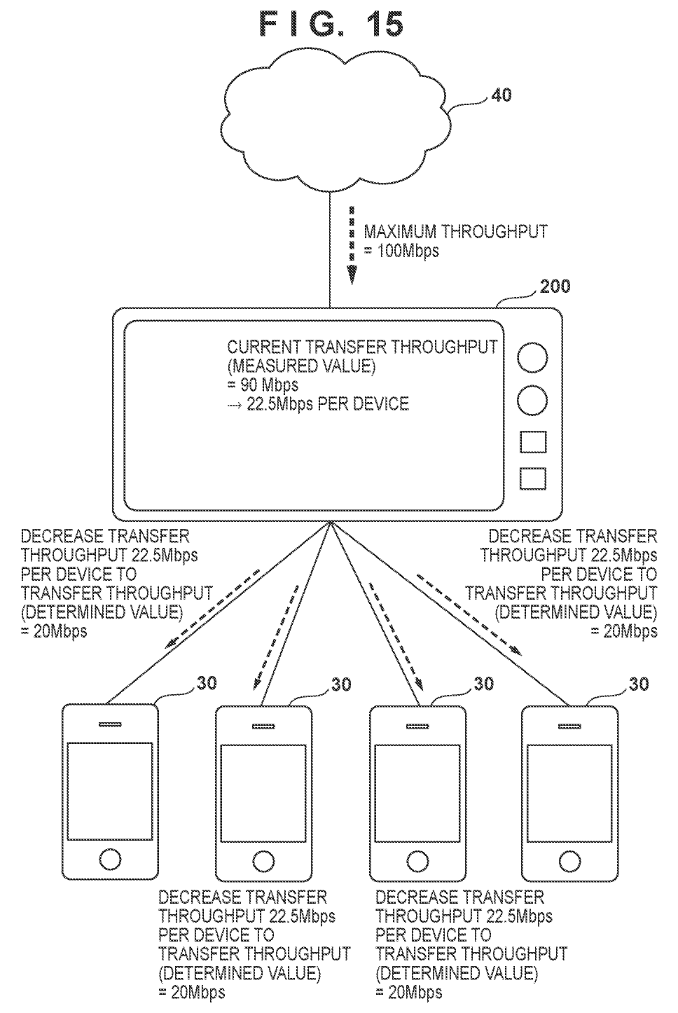

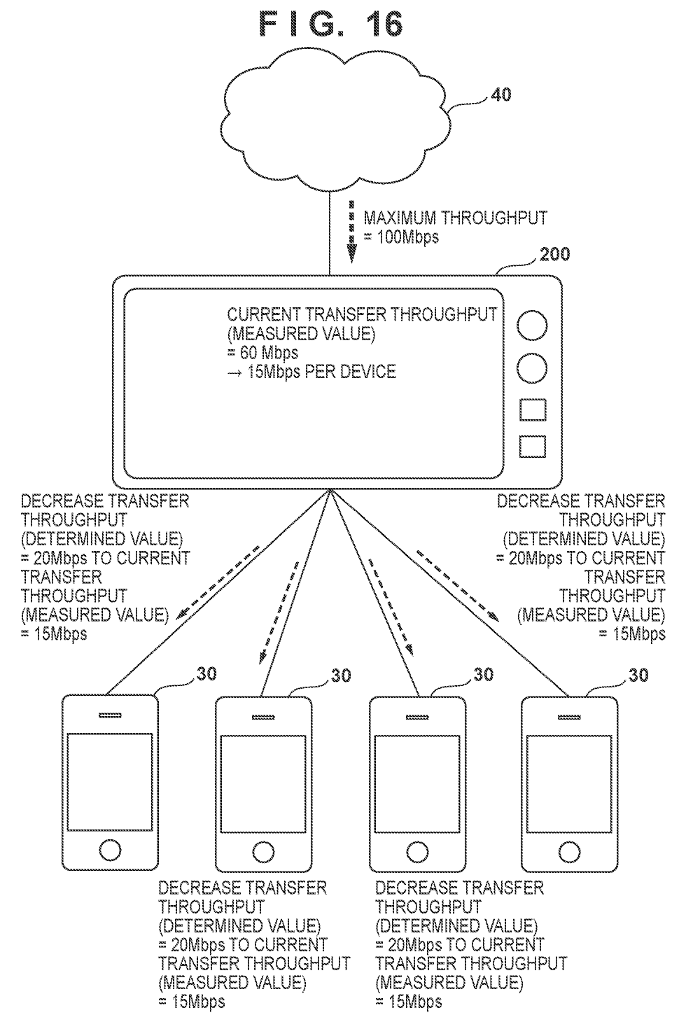

Here, a specific example will be described with reference to FIGS. 15 and 16. In FIG. 15, it is assumed that the maximum throughput of the communication device 200 is 100 Mbps and the connected number of the other communication devices 30, which are connected with the communication device 200, is four. In addition, it is assumed that the current transfer throughput (the measured value) in the processing in the communication device 200 is 90 Mbps.

In this case, in S1402, 22.5 Mbps is obtained by dividing the current transfer throughput (the measured value) 90 Mbps in the processing in the communication device 200 by 4, which is the connected number, and is thus calculated as the current transfer throughput (the measured value) per communication device. Next, the transfer throughput (the determined value) = 20 Mbps is smaller than the current transfer throughput (the measured value) per communication device = 22.5 Mbps, and thus the determination in S1405 is Yes. Then, in S1406, the current transfer throughput (the measured value) = 22.5 Mbps is decreased and changed to be equal to the transfer throughput (the determined value) = 20 Mbps.

In FIG. 16, it is assumed that the maximum throughput of the communication device 200 is 100 Mbps and the connected number of the other communication devices 30, which are connected with the communication device 200, is four. In addition, it is assumed that the current transfer throughput (the measured value) in the processing in the communication device 200 is 60 Mbps.

In this case, in S1402, 15 Mbps is obtained by dividing the current transfer throughput (the measured value) 60 Mbps in the processing in the communication device 200 by 4, which is the connected number, and is thus calculated as the current transfer throughput (the measured value) per communication device. Next, the transfer throughput (the determined value) = 20 Mbps is larger than the current transfer throughput (the measured value) per communication device = 15 Mbps, and thus the determination in S1403 is Yes. Then, in S1404, the transfer throughput (the determined value) = 20 Mbps is decreased to be equal to the current transfer throughput (the measured value) = 15 Mbps.

As described heretofore, in the present embodiment, the current entire transfer throughput of the communication device that functions as the access point (AP) is measured, and the throughput is changed by use of such a measured value. Accordingly, it becomes possible to equally (fairly) allocate the throughput to each of the other communication devices that are connected.

### Modifications

In each of the above-described embodiments, in S601, the measurement unit 255 measures the current throughput for communicating (receiving) data in the communication device 200, and in S1401, the measurement unit 255 measures the current entire transfer throughput of the communication device 200, which functions as an access point (AP).

On the other hand, in a case where a predetermined condition is satisfied, the measurement unit 255 may measure the current throughput for communicating (receiving) data in the communication device 200 or the current entire transfer throughput. For example, the case where the predetermined condition is satisfied may be a case where a predetermined time has elapsed since the previous measurement. In addition, the case where the predetermined condition is satisfied may be a case where the connected number of one or more other communication devices 30 has increased or decreased. Further, the case where the predetermined condition is satisfied may be a case where software or firmware update processing of the communication device 200 has been performed. Alternatively, a case where two or all three of the above conditions may be satisfied may be applicable.

### Summary of embodiments

1. The communication device according to the above embodiment is a communication device (200) capable of relaying data acquired via a network to at least one another communication device (30), the communication device comprising:

an acquisition unit (252) configured to acquire information of a maximum throughput of the communication device;

a connection unit (253) configured to connect with the at least one another communication device; and

a determination unit (254) configured to determine a transfer throughput for transferring data to each of the at least one another communication device, based on a connected number of the at least one another communication device and the information of the maximum throughput.

Accordingly, it becomes possible to distribute an appropriate throughput including a self-terminal (the communication device) and the connected terminals (the other communication devices).

2. The communication device (200) according to the above embodiment, wherein the determination unit determines, as the transfer throughput, a value obtained by dividing the maximum throughput by a total number including the connected number of the at least one another communication device and the communication device.

Accordingly, it becomes possible to equally distribute the transfer throughput for the connected terminal (the other communication device).

3. The communication device (200) according to the above embodiment, wherein the determination unit further determines, as a throughput for receiving data in the communication device, a value obtained by dividing the maximum throughput by a total number including the connected number of the at least one another communication device and the communication device.

Accordingly, it becomes possible to equally distribute the processing throughput of the self-terminal (the communication device) and the transfer throughput for the connected terminal (the other communication device).

4. The communication device (200) according to the above embodiment, further comprising:

a measurement unit (255) configured to measure a current throughput for receiving data in the communication device; and

a change unit (256) configured to change either the current throughput or the transfer throughput, based on a difference between the current throughput measured by the measurement unit and the throughput determined by the determination unit.

Accordingly, it becomes possible to distribute the throughput in consideration of the current processing situation in the communication device.

5. The communication device (200) according to the above embodiment, wherein in a case where the transfer throughput is larger than the current throughput, the change unit changes the transfer throughput to decrease the transfer throughput to be equal to the current throughput.

Accordingly, it becomes possible to equally distribute the processing throughput of the self-terminal (the communication device) and the transfer throughput for the connected terminal (the other communication device).

6. The communication device (200) according to the above embodiment, wherein in a case where the transfer throughput is smaller than the current throughput, the change unit changes the current throughput to decrease the current throughput to be equal to the transfer throughput.

Accordingly, it becomes possible to equally distribute the processing throughput of the self-terminal (the communication device) and the transfer throughput for the connected terminal (the other communication device).

7. The communication device (200) according to the above embodiment, wherein the measurement unit measures the current throughput, in a case where a predetermined condition is satisfied.

This enables the throughput to be changed at an appropriate timing.

8. The communication device (200) according to the above embodiment, wherein the predetermined condition being satisfied includes at least one of: a predetermined time having elapsed from a previous measurement; the connected number of the at least one another communication device having either increased or decreased; and either software or firmware update processing of the communication device having been performed.

This enables the throughput to be changed at an appropriate timing.

9. The communication device (200) according to the above embodiment, further comprising a measurement unit (255) configured to measure a current throughput for receiving data in the communication device, wherein

the determination unit determines the transfer throughput, based on the current throughput, the maximum throughput, and the connected number of the at least one another communication device.

Accordingly, it becomes possible to determine the transfer throughput in consideration of the throughput used by the self-terminal (the communication device).

10. The communication device (200) according to the above embodiment, wherein the determination unit subtracts the current throughput from the maximum throughput to obtain a subtraction result, divides the subtraction result by the connected number to obtain a division result, and determines the division result as the transfer throughput.

Accordingly, it becomes possible to equally distribute the transfer throughput after ensuring the throughput used by the self-terminal (the communication device).

11. The communication device (200) according to the above embodiment, further comprising

a position information acquisition unit (257) configured to acquire position information of each of the at least one another communication device, wherein

the determination unit determines the transfer throughput, further based on the position information.

Accordingly, it becomes possible to distribute the transfer throughput appropriately in accordance with the position of the connected terminal (the other communication device).

12. The communication device (200) according to the above embodiment, wherein

the communication device is mounted on a vehicle (20), and

the determination unit determines a transfer throughput for the at least one another communication device located inside the vehicle to be larger than a transfer throughput for the at least one another communication device located outside the vehicle, based on the position information.

Accordingly, it becomes possible to allocate the transfer throughput by giving priority to the connected terminal (the other communication device) inside the vehicle. Therefore, the communication state of the user, who is located inside the vehicle, and who is considered to have a high need for performing data communication (the connection time is long), is improved, so that a comfortable communication environment can be provided.

13. The communication device (200) according to the above embodiment, wherein

the communication device is mounted on a vehicle, and

the determination unit determines the transfer throughput for the at least one another communication device located in either a driver seat or a front passenger seat of the vehicle to be larger than a transfer throughput for the at least one another communication device located in a rear passenger seat of the vehicle, based on the position information.

Accordingly, it becomes possible to allocate the transfer throughput by giving priority to the communication device, the owner of which is identical to the owner of the vehicle.

14. The communication device (200) according to the above embodiment, wherein

the communication device operates as an access point, and

the at least one another communication device operates as a station.

This enables data communication using the communication device as an access point.

15. The control method of a communication device according to the above embodiment is a control method of a communication device (200) capable of relaying data acquired via a network to at least one another communication device, the control method comprising:

acquiring information of a maximum throughput of the communication device;

connecting with the at least one another communication device; and

determining a transfer throughput for transferring data to each of the at least one another communication device, based on a connected number of the at least one another communication device and the information of the maximum throughput.

Accordingly, it becomes possible to distribute an appropriate throughput including a self-terminal (the communication device) and the connected terminals (the other communication devices).

16. A program according to the above embodiment is

a program for causing a computer to execute a control method of the communication device according to the above embodiment.

This enables processing of the control method to be achieved by a computer.

17. A storage medium according to the above embodiment is

a storage medium storing a program for causing a computer to execute the control method of the communication device according to the above embodiment.

This enables processing of the control method to be achieved by the storage medium.

According to the present invention, the throughput can be appropriately distributed.

### Other Embodiments

In addition, a program for achieving one or more functions that have been described in each of the embodiments is supplied to a system or an apparatus through a network or via a storage medium, and one or more processors on a computer of the system or the apparatus are capable of reading and executing the program. The present invention is also achievable in such an aspect.

The invention is not limited to the foregoing embodiments, and various variations/changes are possible within the spirit of the invention.

What is claimed is:

1. A communication device capable of relaying data acquired via a network to at least one another communication device, the communication device comprising:
an acquisition unit configured to acquire information of a maximum throughput of the communication device;
a connection unit configured to connect with the at least one another communication device; and
a determination unit configured to determine a transfer throughput for transferring data to each of the at least one another communication device, based on a connected number of the at least one another communication device and the information of the maximum throughput.

2. The communication device according to claim 1, wherein the determination unit determines, as the transfer throughput, a value obtained by dividing the maximum throughput by a total number including the connected number of the at least one another communication device and the communication device.

3. The communication device according to claim 1, wherein the determination unit further determines, as a throughput for receiving data in the communication device, a value obtained by dividing the maximum throughput by a total number including the connected number of the at least one another communication device and the communication device.

4. The communication device according to claim 3, further comprising:
a measurement unit configured to measure a current throughput for receiving data in the communication device; and
a change unit configured to change either the current throughput or the transfer throughput, based on a difference between the current throughput measured by the measurement unit and the throughput determined by the determination unit.

5. The communication device according to claim 4, wherein in a case where the transfer throughput is larger than the current throughput, the change unit changes the transfer throughput to decrease the transfer throughput to be equal to the current throughput.

6. The communication device according to claim 4, wherein in a case where the transfer throughput is smaller than the current throughput, the change unit changes the current throughput to decrease the current throughput to be equal to the transfer throughput.

7. The communication device according to claim 4, wherein the measurement unit measures the current throughput, in a case where a predetermined condition is satisfied.

8. The communication device according to claim 7, wherein the predetermined condition being satisfied includes at least one of: a predetermined time having elapsed from a previous measurement; the connected number of the at least one another communication device having either increased or decreased; and either software or firmware update processing of the communication device having been performed.

9. The communication device according to claim 1, further comprising a measurement unit configured to measure a current throughput for receiving data in the communication device, wherein
the determination unit determines the transfer throughput, based on the current throughput, the maximum throughput, and the connected number of the at least one another communication device.

10. The communication device according to claim 9, wherein the determination unit subtracts the current throughput from the maximum throughput to obtain a subtraction result, divides the subtraction result by the connected number to obtain a division result, and determines the division result as the transfer throughput.

11. The communication device according to claim 9, further comprising
a position information acquisition unit configured to acquire position information of each of the at least one another communication device, wherein
the determination unit determines the transfer throughput, further based on the position information.

12. The communication device according to claim 11, wherein
the communication device is mounted on a vehicle, and
the determination unit determines a transfer throughput for the at least one another communication device located inside the vehicle to be larger than a transfer throughput for the at least one another communication device located outside the vehicle, based on the position information.

13. The communication device according to claim 11, wherein
the communication device is mounted on a vehicle, and
the determination unit determines the transfer throughput for the at least one another communication device located in either a driver seat or a front passenger seat of the vehicle to be larger than a transfer throughput for the at least one another communication device located in a rear passenger seat of the vehicle, based on the position information.

14. The communication device according to claim 1, wherein
the communication device operates as an access point, and
the at least one another communication device operates as a station.

15. A control method of a communication device capable of relaying data acquired via a network to at least one another communication device, the control method comprising:
acquiring information of a maximum throughput of the communication device;
connecting with the at least one another communication device; and
determining a transfer throughput for transferring data to each of the at least one another communication device, based on a connected number of the at least one another communication device and the information of the maximum throughput.

16. A non-transitory computer-readable storage medium for causing a computer to execute a control method of a communication device capable of relaying data acquired via a network to at least one another communication device, the control method comprising:
acquiring information of a maximum throughput of the communication device;
connecting with the at least one another communication device; and
determining a transfer throughput for transferring data to each of the at least one another communication device, based on a connected number of the at least one another communication device and the information of the maximum throughput.
